(19) United States
(12) Patent Application Publication
(10) Pub. No.: US 2009/0078810 A1
(43) Pub. Date: Mar. 26, 2009

(54) MAGNETIC TAPE CARTRIDGE

(76) Inventors: Taizo FUKUDA, Miyagi (JP); Shuichi Kikuchi, Miyagi (JP)

Correspondence Address: FROMMER LAWRENCE & HAUG LLP, 745 FIFTH AVENUE, NEW YORK, NY, 10151, US

(21) Appl. No.: 12/233,689

(22) Filed: Sep. 19, 2008

(30) Foreign Application Priority Data
Sep. 21, 2007 (JP) P2007-245980

(51) Int. Cl. G11B 23/107

(52) U.S. Cl. 242/348; 360/132

(57) ABSTRACT

A magnetic tape cartridge includes a reel around which a magnetic tape is wound, a cartridge casing accommodating the reel rotatably, a reel locking member, a biasing member, a spider, and a lubricant. The reel locking member includes a convex sliding portion and engages with the reel to block a rotation thereof. The biasing member biases the reel locking member so that the reel locking member engages with the reel. The spider includes a supporting surface that comes into contact with the sliding portion and has a concave portion concaved at substantially the center thereof, and a wall portion that surrounds the supporting surface, the spider pushing and moving the reel locking member against a bias force of the biasing member to release the engagement between the reel locking member and the reel. The lubricant is applied between the sliding portion and the supporting surface.

### CROSS REFERENCES TO RELATED APPLICATIONS

The present invention contains subject matter related to Japanese Patent Application JP 2007-245980 filed in the Japanese Patent Office on Sep. 21, 2007, the entire contents of which being incorporated herein by reference.

### BACKGROUND OF THE INVENTION

1. Field of the Invention

The present invention relates to a magnetic tape cartridge used as an external storage apparatus of a computer and the like.

2. Description of the Related Art

Well-known magnetic tape cartridges used as external recording media of computers and the like are of a type in which a magnetic tape is wound around a single reel, and a cartridge case accommodates the reel inside rotatably. The magnetic tape cartridges of this type are used to save data of computers and the like.

To prevent loosening of the magnetic tape by a rotation of a tape reel inside the cartridge case when the cartridge is not in use, the magnetic tape cartridge of the single-reel type is provided with a reel locking mechanism for inhibiting the rotation of the tape reel (see Japanese Patent Application Laid-open No. 2005-302240 (paragraphs [0002] to [0012])). A structure of the reel locking mechanism differs depending on a type of the magnetic tape cartridge. For example, in an LTO (linear tape open)-type magnetic tape cartridge, the reel locking mechanism is provided inside a reel hub of the tape reel as shown in FIGS. 11 to 16.

FIG. 11 is an exploded cross-sectional view of a magnetic tape cartridge 101 of this type in the related art. FIG. 12 is a cross-sectional view of the magnetic tape cartridge 101 when not in use. FIG. 13 is a cross-sectional view of the magnetic tape cartridge 101 in use. FIG. 14 is a partially-enlarged cross-sectional view of a reel locking member 113 and a spider 114 of the magnetic tape cartridge 101. FIG. 15 is a plan view showing a tape reel 105. FIG. 16 is a plan view showing the reel locking member 113 from the spider 114 side.

In the magnetic tape cartridge 101, a single tape reel 105 around which the magnetic tape (not shown) is wound is accommodated inside a cartridge 104 constituted by coupling an upper shell 102 and a lower shell 103.

The tape reel 105 includes a reel hub 106 as a winding core of the magnetic tape, an upper flange 107 bonded to an upper end of the reel hub 106, and a lower flange 108 integrally formed at a lower end of the reel hub 106. The reel hub 106 is formed with, at a center portion of an outer bottom surface thereof, an annular chucking gear 109 that engages with a reel rotary-drive axis of a tape driving apparatus (recording/reproducing apparatus) (not shown), the chucking gear 109 exposed via an opening portion 110 formed at a center portion of the lower shell 103. On an inner circumferential side of the chucking gear 109, an annular metal plate 111 for causing the tape reel 105 to be magnetically absorbed to the reel rotary-drive axis is fixed on the outer bottom surface of the reel hub 106 by insert molding.

The reel locking mechanism for inhibiting the rotation of the tape reel 105 in the magnetic tape cartridge 101 when not in use is provided inside the reel hub 106. The reel locking mechanism is composed of gear forming walls 112 formed on an upper bottom surface of the reel hub 106, the reel locking member 113 including engaging teeth 113a that intermesh with a gear portion 112a formed on an upper surface of each of the gear forming walls 112, the spider (reel unlocking member) 114 for releasing the engagement of the gear forming walls 112 and the reel locking member 113, and a reel spring 115 provided between an inner surface of the upper shell 102 and an upper surface of the reel locking member 113 and used for biasing the tape reel 105 toward the lower shell 103 via the reel locking member 113.

The engaging teeth 113a of the reel locking member 113 opposed to the gear portions 112a of the gear forming walls 112 are formed to be annular on a lower surface of the reel locking member 113, and are constantly biased in a direction in which the engaging teeth 113a intermesh with the gear portions 112a due to the reel spring 115. The reel locking member 113 is formed with, on the upper surface thereof, a fitting protrusion 113c having an approximate-cross shape in plan view, and the upper shell 102 is formed with, at substantially the center portion of the inner surface thereof, a fitting concave portion 102a having an approximate-cross shape in plan view and fits with the fitting protrusion 113c.

The spider 114 is substantially triangular and is disposed between the bottom portion of the reel hub 106 and the reel locking member 113. On the lower surface of the spider 114, a total of three legs 114a are formed so as to protrude downward from the vicinity of respective peak portions of the approximate triangle. When the cartridge is not in use, the legs 114a are positioned between gears of the chucking gear 109 via an inserting hole 106a formed at the bottom portion of the reel hub 106. Moreover, a supporting surface 114b for supporting a sliding portion 113b with an arc-shaped cross-section and protrudes from substantially the center portion of the lower surface of the reel locking member 113 is formed at substantially the center portion of the upper surface of the spider 114.

When the thus-structured magnetic tape cartridge 101 of the related art is not in use, the reel locking member 113 is positioned at a locking position shown in FIG. 12 and the tape reel 105 is pressed toward the lower shell 103 by a bias force of the reel spring 115, to thereby intermesh the engaging teeth 113a of the reel locking member 113 with the gear portions 112a of the gear forming walls 112. As a result, the rotation of the tape reel 105 is inhibited.

On the other hand, when the magnetic tape cartridge 101 is in use, the reel rotary-drive axis of the tape driving apparatus (not shown) engages with the chucking gear 109 so that the legs 114a of the spider 114 positioned between the gears of the chucking gear 109 are pressed upward in the cartridge case 104. Accordingly, the reel locking member 113 moves to an unlocking position shown in FIG. 13 while fighting against the bias force of the reel spring 115, thus releasing the engagement between the gear portions 112a and the engaging teeth 113a.

Because the tape reel 105 moves integrally with the reel rotary-drive axis due to a magnetic absorption effect caused between the metal plate 111 and the reel rotary-drive axis, the tape reel 105 is rotationally driven via the chucking gear 109. At this time, a rotational operation of the reel locking member 113 is regulated due to a fitting effect of the fitting protrusion 113c thereof and the fitting concave portion 102a of the upper shell 102, and the spider 114 rotates together with the tape reel 105 using a sliding effect caused between the supporting surface 114b on the upper surface thereof and the sliding portion 113b of the reel locking member 113 that are in point contact. As described above, the approximately hemispherical sliding portion 113b provided at substantially the center portion of the reel locking member 113 is pressed against the upper surface of the spider 114 by the bias force of the reel spring 115, with the result that the sliding portion 113b is abraded by reel rotations at a time of recording or reproducing. Therefore, although the spider 114 originally works to retain a height relationship between the tape reel 105 and the reel locking member 113, a positional relationship in the height direction is changed by the abrasion of the sliding portion 113b. Consequently, the gear portions 112a of the reel hub 106 of the tape reel 105 and the engaging teeth 113a of the reel locking member 113 are inadvertently brought into contact with each other during rotation of the tape reel 105, thus causing traveling failure.

As a method of suppressing abrasion of the sliding portion as described above, there is known, for example, a method in which the sliding portion is formed of a synthetic resin that is excellent in self-lubricity (see, for example, Japanese Patent Application Laid-open No. 2005-4813 (paragraph [0043]).

### SUMMARY OF THE INVENTION

However, even a use of a material excellent in self-lubricity for the sliding portion, for example, hardly suppresses abrasion sufficiently when a tape capacity and a rotating speed of the tape are increased, thus causing a problem of traveling failure of the magnetic tape cartridge due to abrasion.

In view of the above-mentioned circumstances, it is desirable to provide a magnetic tape cartridge capable of suppressing abrasion of a sliding portion that comes into contact with a reel locking member.

According to an embodiment of the present invention, there is provided a magnetic tape cartridge including a reel around which a magnetic tape is wound, a cartridge casing configured to accommodate the reel rotatably, a reel locking member, a biasing member, a spider, and a lubricant. The reel locking member includes a convex sliding portion and is configured to engage with the reel to block a rotation thereof. The biasing member is configured to bias the reel locking member so that the reel locking member engages with the reel. The spider includes a supporting surface that comes into contact with the sliding portion and has a concave portion concaved at substantially the center thereof, and a wall portion that surrounds the supporting surface, the spider configured to push and move the reel locking member against a bias force of the biasing member to release the engagement between the reel locking member and the reel. The lubricant is applied between the sliding portion and the supporting surface.

In the embodiment of the present invention, by shaping the supporting surface of the spider as the concave portion concaved at substantially the center portion thereof, the sliding portion can stably rotate at substantially the center portion of the supporting surface while being in contact therewith, whereby a magnetic tape cartridge having stable traveling performance can be obtained. Further, application of the lubricant between the supporting surface and the sliding portion suppresses abrasion of the sliding portion to thus prevent a rotational stop that is due to the abrasion caused during rotation. Furthermore, provision of the wall portion around the supporting surface can prevent dispersion of the lubricant during rotation of the reel.

Further, in the magnetic tape cartridge according to the embodiment of the present invention, the concave portion of the spider has an arc-shaped cross-section with a radius R1. By thus forming the concave portion with the arc-shaped cross-section, it becomes easier to bring the sliding portion and the supporting surface in point contact.

Further, in the magnetic tape cartridge according to the embodiment of the present invention, the convex sliding portion has an arc-shaped cross-section with a radius R2, the radius R2 being smaller than the radius R1. By thus setting the radius R1 to be larger than the radius R2, it becomes possible to bring the sliding portion and the supporting surface in point contact.

Further, in the magnetic tape cartridge according to the embodiment of the present invention, the radius R1 is larger than 30 mm and smaller than 120 mm. Thus, stable traveling performance can be obtained while suppressing abrasion of the sliding portion. Specifically, when the radius R1 is 30 mm or less, a contact pressure between the sliding portion and the supporting surface becomes high, and the abrasion of the sliding portion is easily caused thereby. On the other hand, the radius R1 of 120 mm or more causes an increase in flatness of the supporting surface, whereby the sliding portion can hardly rotate stably at the center portion of the supporting surface during rotation of the tape. As a result, an axial deviation is caused and the traveling performance is destabilized to thus cause traveling failure. Therefore, it is desirable to set the radius R1 as described above.

Further, in the magnetic tape cartridge according to the embodiment of the present invention, the wall portion has a height of 0.2 mm or more and 0.6 mm or less. Thus, the wall portion can prevent dispersion of the lubricant during rotation of the tape while preventing the traveling failure from being caused. Specifically, when the height of the wall portion is larger than 0.6 mm, the wall portion may come into contact with other components of the magnetic tape cartridge to thus cause traveling failure. Furthermore, the height of less than 0.2 mm hardly suppresses the dispersion of the lubricant sufficiently. Therefore, it is desirable to set the height of the wall portion as described above.

Further, in the magnetic tape cartridge according to the embodiment of the present invention, the spider has a groove formed on a circumferential portion of the supporting surface. By thus providing the groove, the lubricant dispersed during rotation of the reel can be blocked, whereby it becomes possible to additionally suppress dispersion of the lubricant.

As described above, according to the embodiment of the present invention, it is possible to obtain a magnetic tape cartridge in which abrasion of a sliding portion is suppressed and which has stable traveling performance.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a perspective view showing an entire magnetic tape cartridge according to an embodiment of the present invention;

FIG. 2 is a perspective view showing the entire magnetic tape cartridge shown in FIG. 1 when seen from a lower surface side;

FIG. 3 is an exploded perspective view of the magnetic tape cartridge shown in FIG. 1;

FIG. 4 is a schematic cross-sectional view showing the magnetic tape cartridge shown in FIG. 1 when not in use;

FIG. 5 is a schematic cross-sectional view showing the magnetic tape cartridge shown in FIG. 1 while in use;

FIG. 6 is a plan view showing an internal structure of a reel hub in which a reel locking mechanism of the magnetic tape cartridge shown in FIG. 1 is constituted;

FIG. 7 is an exploded cross-sectional view schematically showing the magnetic tape cartridge shown in FIG. 1;

FIG. 8 is a partially-enlarged cross-sectional view showing a reel locking member and a spider of the magnetic tape cartridge shown in FIG. 1;

FIG. 9 is a plan view showing the spider according to the embodiment of the present invention;

FIG. 10 is a partially-enlarged cross-sectional view showing a reel locking member and a spider of a magnetic tape cartridge according to a modification of the present invention;

FIG. 11 is an exploded cross-sectional view schematically showing a magnetic tape cartridge of the related art;

FIG. 12 is a schematic cross-sectional view showing the magnetic tape cartridge shown in FIG. 11 when not in use;

FIG. 13 is a schematic cross-sectional view showing the magnetic tape cartridge shown in FIG. 11 while in use;

FIG. 14 is a partially-enlarged cross-sectional view showing a reel locking member and a spider of the magnetic tape cartridge shown in FIG. 11;

FIG. 15 is a plan view showing a tape reel; and

FIG. 16 is a plan view showing the reel locking member when seen from the spider side.

### DESCRIPTION OF PREFERRED EMBODIMENTS

Hereinafter, an embodiment of the present invention will be described with reference to the drawings.

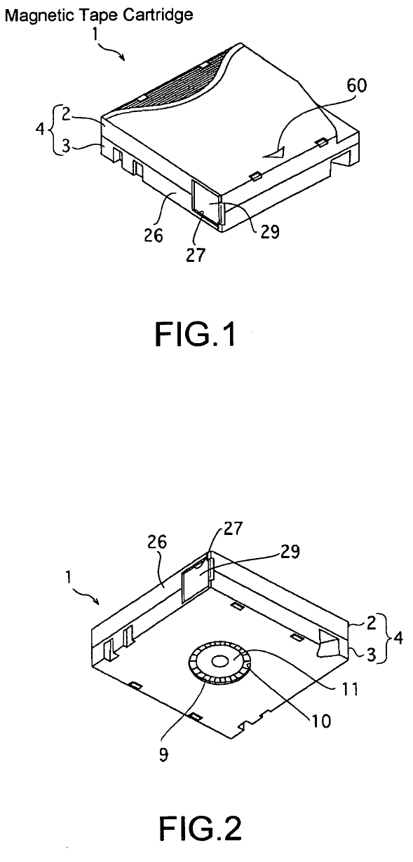

FIGS. 1 to 9 show the embodiment of the present invention.

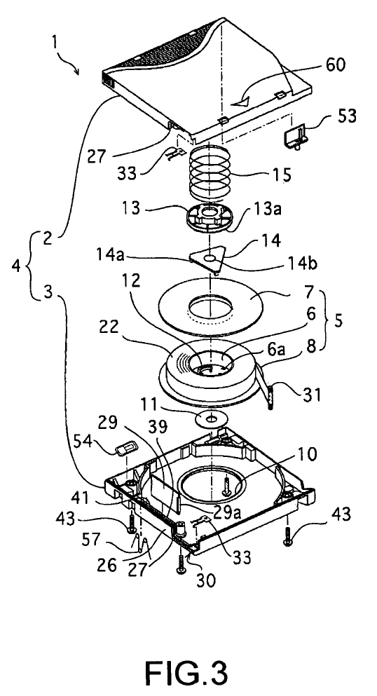

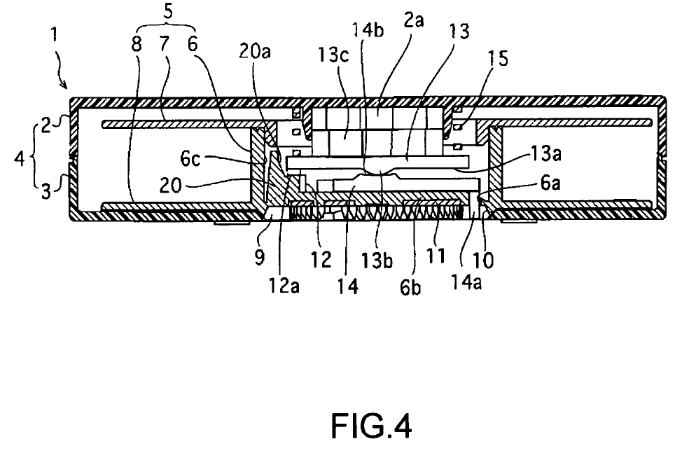

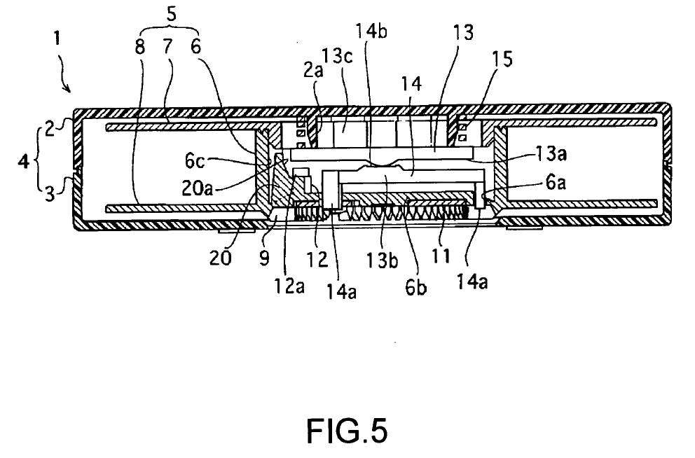

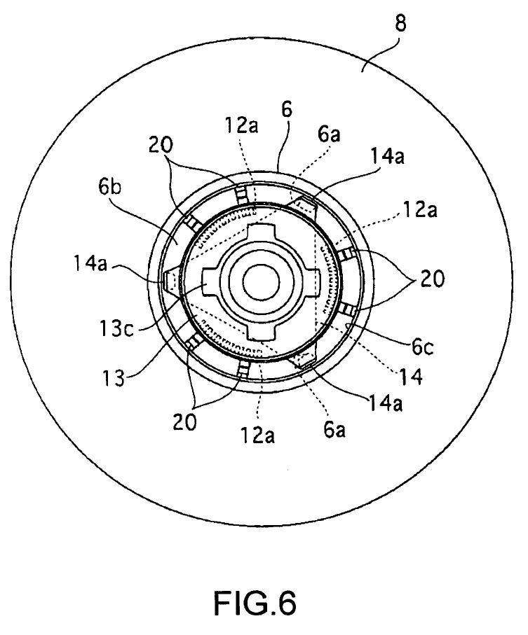

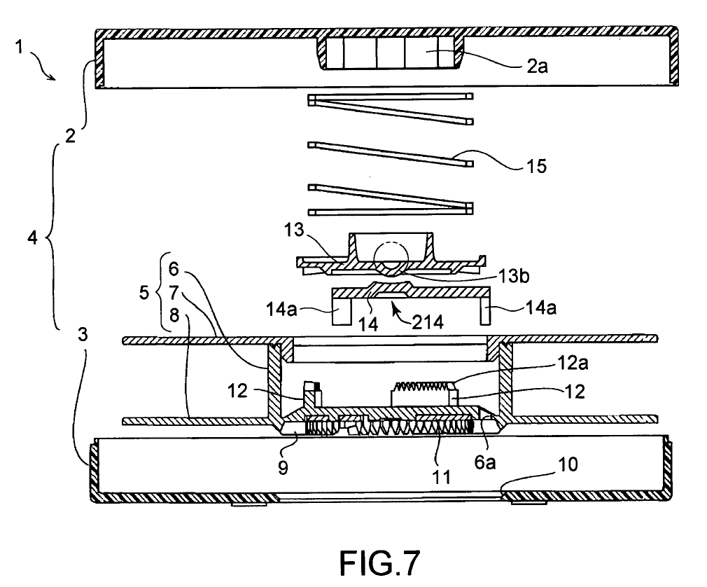

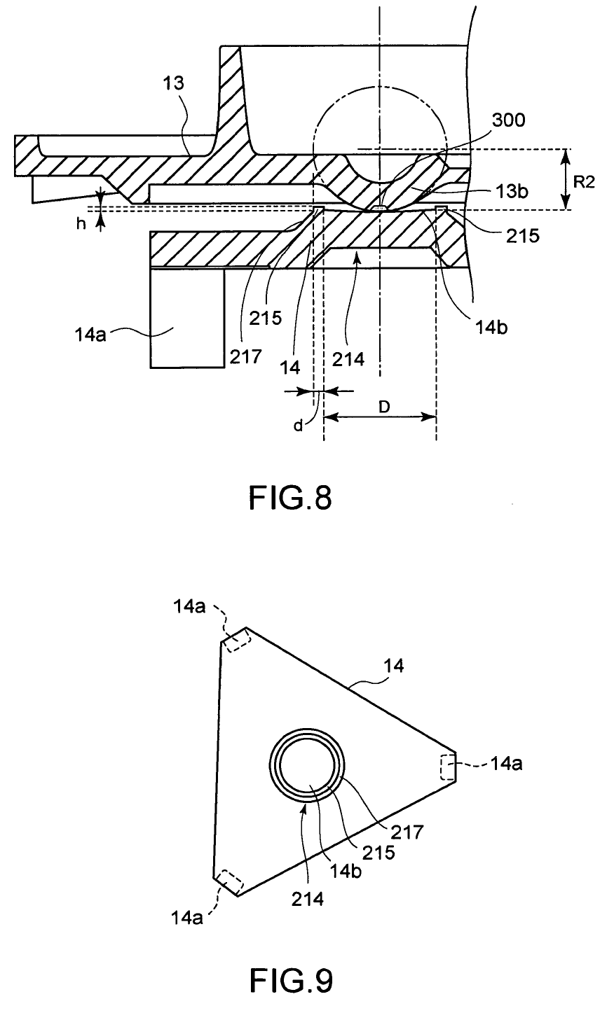

FIG. 1 is a perspective view showing an entire magnetic tape cartridge 1 according to the embodiment of the present invention. FIG. 2 is a perspective view showing the entire magnetic tape cartridge 1 when seen from a lower surface side. FIG. 3 is an exploded perspective view of the magnetic tape cartridge 1. FIG. 4 is a schematic cross-sectional view showing the magnetic tape cartridge 1 when not in use. FIG. 5 is a schematic cross-sectional view showing the magnetic tape cartridge 1 in use. FIG. 6 is a plan view showing an internal structure of a reel hub in which a reel locking mechanism is constituted. FIG. 7 is an exploded cross-sectional view schematically showing the magnetic tape cartridge 1. FIG. 8 is a partially-enlarged cross-sectional view showing a reel locking member 13 and a spider 14 of the magnetic tape cartridge 1. FIG. 9 is a plan view showing the spider 14. It should be noted that in FIGS. 4, 5, and 7, illustrations of a magnetic tape are omitted.

As shown in FIGS. 1 to 3 and 7, the magnetic tape cartridge 1 is structured such that a tape reel 5 as a single reel around which a magnetic tape 22 is wound is accommodated rotatably inside a cartridge case 4 as a cartridge casing constituted by coupling an upper shell 2 and a lower shell 3 using a plurality of screwing members 43. The tape reel 5 includes a reel hub 6, an upper flange 7 connected to an upper end of the reel hub 6, and a lower flange 8 integrally formed at a lower end of the reel hub 6, each of which is formed as an injection-molded body formed of a synthetic resin.

The tape reel 5 is formed with, at a center of a lower surface thereof, an annular chucking gear 9 that engages with a reel rotary-drive axis of a tape driving apparatus, the chucking gear 9 being exposed via an opening portion 10 formed at substantially the center of the lower shell 3 (FIG. 2). On an inner circumferential side of the chucking gear 9, an annular metal plate 11 that magnetically absorbs the reel rotary-drive axis is fixed on an outer bottom surface of the reel hub 6 by insert molding.

A reel spring 15 as a biasing member, the reel locking member 13, and the spider 14 are disposed between an inner surface of the upper shell 2 and the tape reel 5. The reel spring 15, the reel locking member 13, and the spider 14 constitute a reel locking mechanism for inhibiting a rotation of the tape reel 5 when the magnetic tape cartridge 1 is not in use. It should be noted that details of the reel locking mechanism will be described later.

A drawing port 27 for drawing out one end of the magnetic tape 22 is provided on one sidewall 26 of the cartridge case 4. A wall portion 39 opposed to the sidewall 26 with a predetermined gap therebetween is formed on an inner side of the sidewall 26, and the sidewall 26 and the wall portion 39 form a guide groove 41 for guiding a movement of a slide door 29 that moves to open and close the drawing port 27. It should be noted that although illustration is omitted, the guide groove 41 is similarly structured on the upper shell 2 side in addition to the lower shell 3 side.

The slide door 29 is provide with, at an end portion on one side thereof, an engaging portion 29a that engages with a tape conveying mechanism of the tape driving apparatus to open the slide door 29. A W-shaped torsion spring 57 for biasing the slide door 29 toward a closing position is accommodated inside the guide groove 41.

Moreover, on an inner side of other sidewalls of the cartridge case 4, a safety tag 53 for preventing information recorded on the magnetic tape 22 from being erroneously deleted is attached slidably, and an IC substrate 54 capable of reading/writing a content of the information recorded on the magnetic tape 22 while in a non-contact state is provided obliquely.

Furthermore, a display 60 indicating a direction to insert a cartridge with respect to the tape driving apparatus is provided on an upper front surface of the upper shell 2.

A leader pin 31 made of metal is fixed to one end of the magnetic tape 22. The leader pin 31 is detachable from a pin retaining portion 30 provided on an inner side of the drawing port 27. The pin retaining portion 30 is composed of elastic retainers 33 provided vertically symmetrically on an inner upper wall surface (inner surface of the upper shell 2) of the cartridge case 4 and an inner bottom wall surface (inner surface of the lower shell 3) thereof, respectively. The leader pin 31 is supported by the elastic retainers 33 at upper and lower ends thereof.

Next, the reel locking mechanism of the tape reel 5 will be described with reference to FIGS. 4 to 6.

The reel locking mechanism for inhibiting the rotation of the tape reel 5 when the magnetic tape cartridge 1 is not in use is provided inside the reel hub 6. The reel locking mechanism is composed of gear forming walls 12 erected on an upper surface of a bottom portion 6b of the reel hub 6, the reel locking member 13 including engaging teeth 13a that intermesh with a gear portion 12a formed on an upper surface of each of the gear forming walls 12, the spider (reel unlocking member) 14 for releasing the engagement between the gear forming walls 12 and the reel locking member 13, and the reel spring 15 disposed between the inner surface of the upper shell 2 and the upper surface of the reel locking member 13 and biases the tape reel 5 toward the lower shell 3 via the reel locking member 13.

The gear forming walls 12 each have an arc shape and are provided at, for example, three positions on a concyclic circumference that centers on an axis of the reel hub 6 at regular intervals, on the upper surface of the bottom portion 6b of the reel hub 6 (FIG. 6). The reel locking member 13 is circular and the engaging teeth 13a thereof is provided annularly on the lower surface of the reel locking member 13 while opposing the gear portions 12a of the gear forming walls 12. The reel locking member 13 is formed with, on the upper surface thereof, a fitting protrusion 13c having an approximate-cross shape in plan view (FIG. 6). The upper shell 2 is formed with, at substantially the center portion of the inner surface thereof, a fitting concave portion 2a having an approximate-cross shape in plan view and fits with the fitting protrusion 13c. The reel locking member 13 is movable in an axial direction of the tape reel 5 (thickness direction of the cartridge) along the fitting concave portion 2a, but a relative movement thereof in a rotational direction is regulated.

The reel spring 15 is a coil spring, and one end thereof is engaged to the circumference of the fitting concave portion 2a on the inner surface of the upper shell 2 while the other end thereof is engaged to the circumference of the fitting protrusion 13c on the upper surface of the reel locking member 13. The reel spring 15 constantly biases the reel locking member 13 in a direction in which the engaging teeth 13a of the reel locking member 13 intermesh with the gear portions 12a of the gear forming walls 12.

The spider 14 is substantially triangular (FIGS. 6 and 9) and is disposed between the bottom portion 6b of the reel hub 6 and the reel locking member 13. On the lower surface of the spider 14, a total of three legs 14a are formed so as to protrude downward from the vicinity of respective peak portions of the approximate triangle. When the cartridge is not in use, the legs 14a are positioned between gears of the chucking gear 9 via an inserting hole 6a formed at the bottom portion 6b of the reel hub 6. Moreover, a supporting surface 14b for supporting a sliding portion 13b with an arc-shaped cross-section and protrudes from substantially the center portion of the lower surface of the reel locking member 13 is formed at substantially the center portion of the upper surface of the spider 14.

When the magnetic tape cartridge 1 is not in use, the reel locking member 13 is positioned at a locking position shown in FIG. 4 where the tape reel 5 is pressed toward the lower shell 3 by a bias force of the reel spring 15, thus intermeshing the engaging teeth 13a of the reel locking member 13 with the gear portions 12a of the gear forming walls 12. As a result, the rotation of the tape reel 5 is inhibited.

On the other hand, when the magnetic tape cartridge 1 is in use, the reel rotary-drive axis of the tape driving apparatus (not shown) engages with the chucking gear 9 so that the legs 14a of the spider 14 positioned between the gears of the chucking gear 9 are pressed upward toward an inner side of the cartridge case 4. Accordingly, the reel locking member 13 moves to an unlocking position shown in FIG. 5 while fighting against the bias force of the reel spring 15, thus releasing the engagement between the gear portions 12a and the engaging teeth 13a.

Because the tape reel 5 moves integrally with the reel rotary-drive axis due to a magnetic absorption effect caused between the metal plate 11 and the reel rotary-drive axis, the tape reel 5 is rotationally driven via the chucking gear 9. At this time, a rotational operation of the reel locking member 13 is regulated due to a fitting effect of the fitting protrusion 13c to the fitting concave portion 2a of the upper shell 2, and the spider 14 rotates together with the tape reel 5 using a sliding effect caused between the supporting surface 14b on the upper surface thereof and the sliding portion 13b of the reel locking member 13 that are in point contact.

Position regulating ribs 20 for regulating an axial deviation of the reel locking member 13 from an axial center position of the tape reel 5 are provided inside the reel hub 6 so as to oppose an outer circumferential portion of the reel locking member 13. The position regulating ribs 20 provided in a plural number are erected on an outer circumferential side of each of the gear forming walls 12 on the upper surface of the bottom portion 6b of the reel hub 6. The position regulating ribs 20 are radially connected at a total of six places, that is, two each on the outer circumferential surface of the gear forming walls 12 that are provided three in total (FIGS. 4 and 6).

The reel locking member 13 is formed of, for example, POM (polyoxyethylene), and the spider 14 is formed of, for example, a synthetic resin containing PC (polycarbonate), PBT (polybutylene terephthalete), and/or an additive. Here, by using the synthetic resin containing an additive as a material for the spider 14, sliding performance and rigidity are enhanced to thus suppress abrasion of the sliding portion 13b.

As shown in FIG. 8, the sliding portion 13b has a spherical surface and is formed as a convex portion having an arc-shaped cross-section with a radius R2 of about 3 mm.

As shown in FIGS. 8 and 9 in the embodiment of the present invention, a convex portion 214 is provided on a surface opposed to the surface from which the legs 14a of the spider 14 protrude. The convex portion 214 includes an oblique side surface 217 that is formed such that a planar area of the convex portion 214 becomes smaller from a bottom surface toward a top surface thereof, the supporting surface 14b that is circular in plan view and supports the sliding portion 13b, and a dispersion preventing wall 215 as a wall portion provided around the supporting surface 14b. The dispersion preventing wall 215 is annular in plan view. The supporting surface 14b is a concave portion that is concaved at substantially the center portion thereof.

The supporting surface 14b has a spherical surface and an arc-shaped cross-section whose diameter D in a plane thereof is about 5 mm and radius R1 is set to be larger than 30 mm and smaller than 120 mm so that the center portion of the supporting surface 14b is concaved at a maximum degree. In the embodiment of the present invention, the supporting surface 14b has an arc-shaped cross-section with the radius R1 of 90 mm. By thus forming the supporting surface 14b as the concave portion having the arc-shaped cross-section, the sliding portion 13b can rotate at the center portion of the supporting surface 14b. Thus, an axial deviation is prevented and stable traveling performance of the magnetic tape 22 can be secured. Moreover, by setting the radius R1 to be larger than the radius R2 of the sliding portion 13b, it becomes possible to bring the sliding portion 13b and the supporting surface 14b in point contact. Here, when the radius RI of the supporting surface 14b is 30 mm or less in the arc, a contact pressure between the sliding portion 13b and the supporting surface 14b becomes high, and the abrasion of the sliding portion 13b is easily caused thereby. On the other hand, the radius R1 of 120 mm or more in the arc of the supporting surface 14b causes an increase in flatness of the supporting surface 14b, whereby the sliding portion 13b can hardly rotate stably at the center portion of the supporting surface 14b during rotation of the tape. As a result, an axial deviation is caused and the traveling performance is destabilized to thus cause traveling failure.

A grease 300 of about 2 mg±1 mg is applied as the lubricant between the sliding portion 13b and the supporting surface 14b. The application of the grease 300 as described above significantly suppresses the abrasion of the sliding portion 13b. For example, a 300-hour traveling test resulted in the abrasion of the sliding portion 13b of about 100 to 200 μm when the grease 300 was not applied, whereas the test resulted in the abrasion of about several μm, that is, a level within a measurement error when the grease 300 was applied, which shows that the level of abrasion is significantly suppressed to as much as about 1/100 when the grease 300 is applied. As described above, the use of the grease 300 suppresses the abrasion of the sliding portion 13b. Thus, the height relationship between the tape reel 5 and the reel locking member 13 is maintained. Therefore, the gear portions 12a of the reel hub 6 of the tape reel 5 and the engaging teeth 13a of the reel locking member 13 can be prevented from being brought into contact with one another during rotation of the tape reel 5 to stop the rotation due to the change in height relationship between the tape reel 5 and the reel locking member 13 that is caused by the abrasion of the sliding portion 13b, thereby preventing traveling failure. As a result, it becomes possible to obtain a magnetic tape cartridge having stable traveling performance.

In addition, the provision of the dispersion preventing wall 215 on the spider 14 can prevent dispersion of the grease 300 during rotation of the tape reel 5. A height h of the dispersion preventing wall 215 only needs to be 0.2 mm or more and 0.6 mm or less, and is about 0.3 mm in this embodiment. Further, a width d is about 0.5 mm. Here, when the height h is larger than 0.6 mm, the reel locking member 13 and the dispersion preventing wall 215 may come into contact with each other due to the tilt of the reel locking member 13, to thus cause traveling failure. Furthermore, when the height h is smaller than 0.2 mm, the dispersion of the grease 300 can hardly be suppressed sufficiently, resulting in the dispersion of the grease 300 to an outer side of the dispersion preventing wall 215. It should be noted that in the embodiment of the present invention, the height h of the dispersion preventing wall 215 is 0.3 mm, but the numerical value thereof can suitably be changed as long as collision with the reel locking member 13 is avoided and the dispersion of the grease 300 is prevented.

As described above, according to the embodiment of the present invention, the supporting surface 14b of the spider 14 that comes into contact with the sliding portion 13b is formed as a concave portion having the arc-shaped cross-section, and the grease 300 is applied between the supporting surface 14b of the spider 14 and the sliding portion 13b. As a result, the abrasion of the sliding portion 13b is suppressed, and a magnetic tape cartridge having stable traveling performance can thus be obtained. Furthermore, the provision of the dispersion preventing wall 215 around the supporting surface 14b can prevent the dispersion of the grease 300.

(Modification)

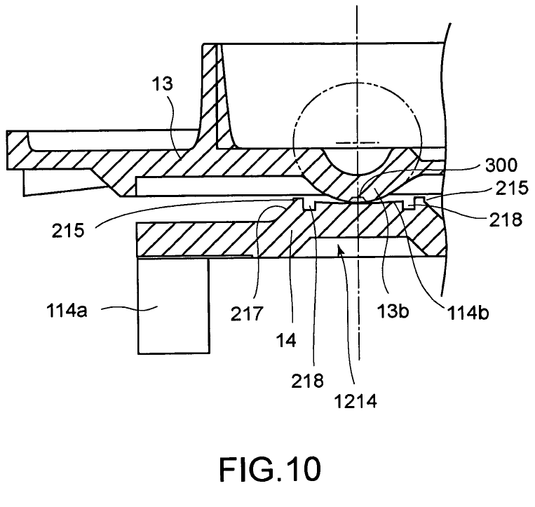

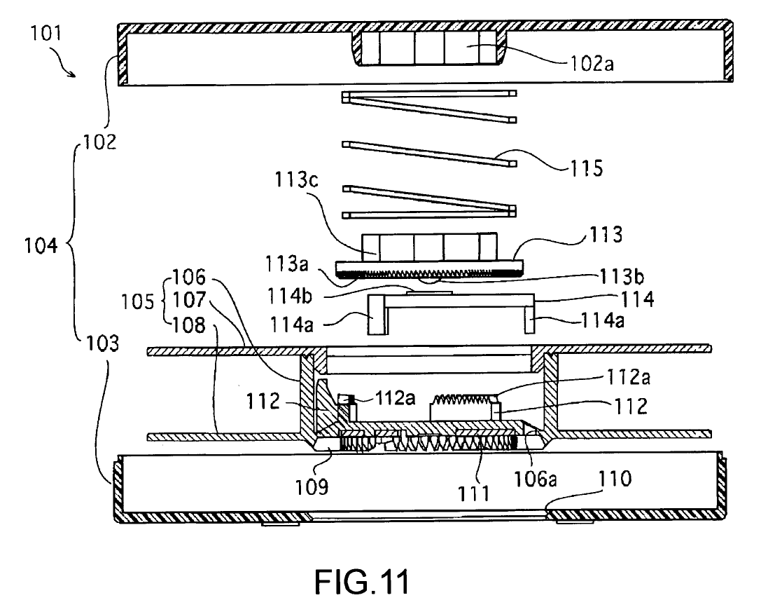

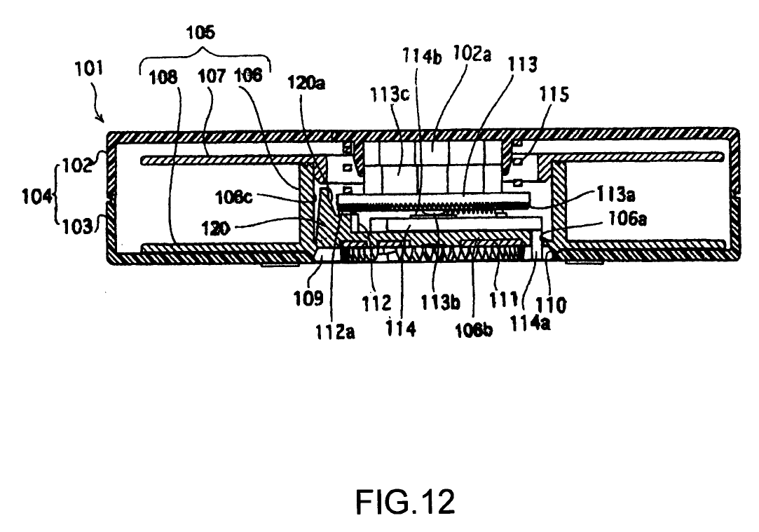

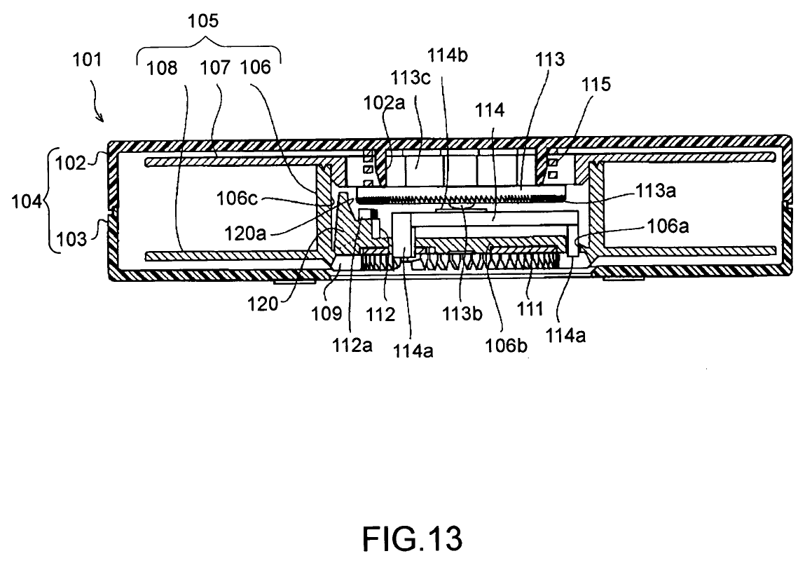

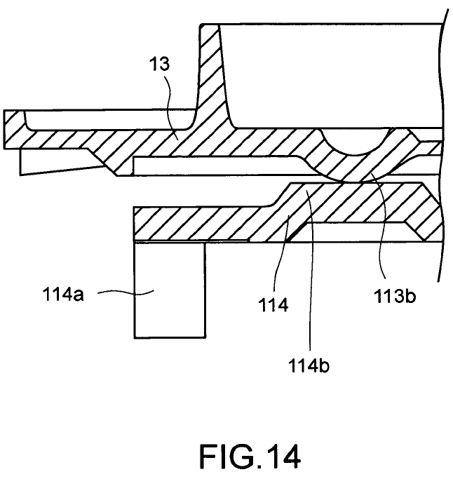

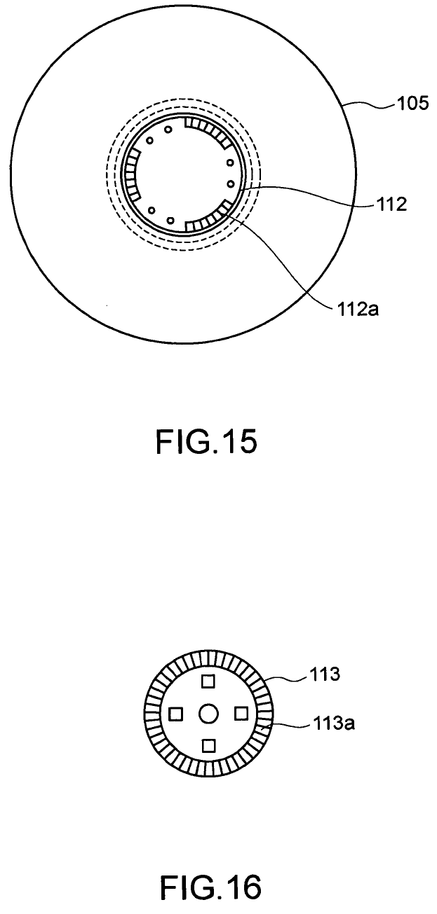

A modification will now be described with reference to FIG. 10. FIG. 10 is a partially-enlarged view of the reel locking member 13 and the spider 14 in a magnetic tape cartridge according to the modification. It should be noted that structures similar to those of the above embodiment are denoted by the same reference symbols, and descriptions thereof will be omitted.

As shown in FIG. 10, a convex portion 1214 includes the oblique side surface 217 that is formed such that a planar area of the convex portion 1214 becomes smaller from a bottom surface toward a top surface thereof, a supporting surface 114b that is circular in plan view and supports the sliding portion 13b, and the dispersion preventing wall 215 that is annular in plan view and provided around the supporting surface 114b. A groove 218 is formed on a circumferential portion of the supporting surface 114b. In other words, the groove 218 is provided while being in contact with an inner circumferential portion of the dispersion preventing wall 215. The groove 218 is annular in plan view. The thus-structured groove 218 can block the grease 300 that is dispersed during the rotation of the tape, whereby it becomes possible to additionally suppress dispersion of the grease 300.

It should be understood by those skilled in the art that various modifications, combinations, sub-combinations and alterations may occur depending on design requirements and other factors insofar as they are within the scope of the appended claims or the equivalents thereof.

What is claimed is:

1. A magnetic tape cartridge, comprising:
a reel around which a magnetic tape is wound;
a cartridge casing configured to accommodate the reel rotatably;
a reel locking member including a convex sliding portion and configured to engage with the reel to block a rotation thereof;
a biasing member configured to bias the reel locking member so that the reel locking member engages with the reel;
a spider including a supporting surface that comes into contact with the sliding portion and has a concave portion concaved at substantially the center thereof, and a wall portion that surrounds the supporting surface, the spider configured to push and move the reel locking member against a bias force of the biasing member to release the engagement between the reel locking member and the reel; and
a lubricant applied between the sliding portion and the supporting surface.

2. The magnetic tape cartridge according to claim 1, wherein the concave portion of the spider has an arc-shaped cross-section with a radius R1.

3. The magnetic tape cartridge according to claim 2, wherein the convex sliding portion has an arc-shaped cross-section with a radius R2, the radius R2 being smaller than the radius R1.

4. The magnetic tape cartridge according to claim 2, wherein the radius R1 is larger than 30 mm and smaller than 120 mm.

5. The magnetic tape cartridge according to claim 1, wherein the wall portion has a height of 0.2 mm or more and 0.6 mm or less.

6. The magnetic tape cartridge according to claim 1, wherein the spider has a groove formed on a circumferential portion of the supporting surface.
